(19) United States
(12) Patent Application Publication
(10) Pub. No.: US 2016/0205949 A1
(43) Pub. Date: Jul. 21, 2016

(54) DEVICE FOR BAKNG DOUGH PIECES

(71) Applicant: R. WEISS VERPACKUNGSTECHNIK GMBH & CO. KG, Crailsheim (DE)

(72) Inventor: Reinald Weiss, Schopfloch (DE)

(21) Appl. No.: 14/913,444

(22) PCT Filed: Aug. 21, 2014
(86) PCT No.: PCT/EP2014/067834

§ 371 Date: Apr. 8, 2016

(30) Foreign Application Priority Data
Aug. 23, 2013 (DE) 10 2013 109 141.5

(51) Int. Cl. A21B 7/00; A21B 3/07; A21B 1/48

(52) U.S. Cl. CPC A21B 7/00; A21B 1/48; A21B 3/07

(57) ABSTRACT

A device for selectively baking or crisp baking dough pieces based on a customer request for requested baked goods includes at least one input storage and at least one associated feeding device for respectively storing and feeding various kinds of dough pieces. A throughput baking oven selectively bakes or crisp bakes the dough pieces. The throughput oven has a conveyor for transporting the dough pieces through the baking oven. The throughput oven has only one oven space, and the conveyor has at least two conveyor belts passing through the oven space capable of simultaneously transporting dough pieces through the oven space. At least one output storage receives and stores the baked goods made from the dough pieces. After the customer request made through an operating unit, the requested baked goods are transported from the at least one output storage to the dispensing unit to be dispensed therein.

### CROSS-REFERENCE TO RELATED APPLICATIONS

This application is national stage of International Application No. PCT/EP2014/067834, filed Aug. 21, 2014 and claims benefit to German Patent Application No. 10 2013 109 141.5, filed Aug. 23, 2013, both of which are incorporated herein by reference herein.

### TECHNICAL FIELD

The invention refers to a device for baking dough pieces.

### BACKGROUND

Such a device is described, for example, in DE 10 2009 026 619 A1 and can be used especially in supermarkets, as it is capable of baking raw or re-baked dough pieces so they are ready-to-eat. Customers can then make a selection among various baked goods by ordering the number and type of baked goods they wish using a serving unit that can be a touch screen.

The disadvantage of the known devices is that they occupy a relatively large space owing to their complexity and the product variety that customers want to have.

### SUMMARY

It is the task of this invention to provide a compact and economical, yet nonetheless flexible device for baking dough pieces.

In the above-mentioned device, this task is solved by the throughput baking oven having only one oven space and the conveyor having at least two conveyors belts passing through the oven space, capable of transporting dough pieces simultaneously through the oven space.

The advantages of the invention are especially noticeable in that merely one single oven space is provided through which at least the two conveyor belts pass that can transport different kinds of dough pieces through this single oven space simultaneously. This arrangement saves considerable space while using at least two conveyor belts allows great flexibility attainable through geometric and/or control technology measures.

An especially preferred embodiment provides at least two conveyor belts running parallel to one another, preferably horizontally or slightly inclined. Such an arrangement contributes to the compactly designed device according to the invention. The heat in this single baking oven is distributed preferably uniformly in the area of the at least two conveyor belts. Alternately, uneven heat distribution is generated in the single oven space with respect to the conveyor belts, for example by different heat radiation elements or heat barriers in the oven space.

According to an advantageous design of the invention, the conveyor belts have different conveyor widths to bake breads or baguettes arranged behind one another on a wide conveyor belt and smaller baked goods like rolls on a narrower conveyor belt, for example. Needless to say, it is also possible to bake several smaller baked goods beside one another on the wide belts.

Especially preferable is the provision of an electric control device to adjust the speeds of the conveyor belts independently from one another. In this way, baked goods that need longer baking time (e.g. breads) can be transported more slowly through the oven space than baked goods that can be baked in a shorter period of time (e.g. rolls). Here, it is preferable for the speeds of both conveyor belts to be variably adjustable.

Especially preferred is the installation of an electric control device to adjust a different timing of the conveyor belts for the dwelling time of preferably intermittently transported baked products in the baking oven. Thus, for example, breads on a conveyor belt can remain over longer periods in the oven space than rolls remaining on another conveyor belt. In this case, one or both (or all) conveyor belts can be stopped once or several times during the baking process. In combination with an option to allow the conveyor belts to run on different speeds, even greater variation speeds can be expected.

A flexible and easy setup of the device according to the invention is done by arranging the at least one input storage, the throughput baking oven and the at least one output storage in different housings. In this way, a relatively easy assembly is not only possible but the output storage can be set up in a supermarket's sales room while the input storage and throughput baking oven are set up behind a wall in a room accessible only to supermarket employees.

Additional space reduction is achieved if meander- or serpentine-shaped endless belts are arranged in the at least one input and/or output storage. Preferably, circulating storage carriers are firmly attached to it in the corresponding storage to receive dough pieces or finished baked goods, in which case the main movement of these storage carriers takes place in vertical direction.

Furthermore, according to a preferred embodiment, utilization of cramped spaces is achieved by transporting the dough pieces non-linearly from the input storage to the baking oven. It can especially be provided for the transportation path to change directions by about 90° at least once, preferably twice. It is especially preferable if the dough pieces are transported obliquely in front of the oven.

In a preferred variant capable of transporting the dough pieces obliquely, a transportation conveyor is arranged, for example, above the feeding device and running across its width for transporting the dough pieces from the input storage to the baking oven is provided. In a corresponding variant, the dough pieces can be brought from the upper side of the input storage to the transportation conveyor, which then transports the dough pieces laterally away and especially obliquely in front of the baking oven.

Especially when the feeding device places several dough pieces in the input storage, it is advantageous if the relative position of these dough pieces to one another is largely maintained while they are transported to the baking oven, inside the baking oven, and out of the baking oven, at least until the freshly baked dough pieces are stored in the output storage.

Advantageous further developments of the invention are found in other aspects of the disclosure.

### BRIEF DESCRIPTION OF THE DRAWINGS

The invention is explained in more detail below by means of the following drawings:

FIG. 1 is a schematic side cross-sectional view of the device according to the invention;

FIG. 2 is a top view of the device according to the invention;

FIG. 3 is a side view of the device according to FIGS. 1 and 2 seen from the serving side; and

FIGS. 4a, b are respectively a schematic cross-sectional view through the baking oven and a schematic top view of the conveyor belts of the baking oven.

### DETAILED DESCRIPTION

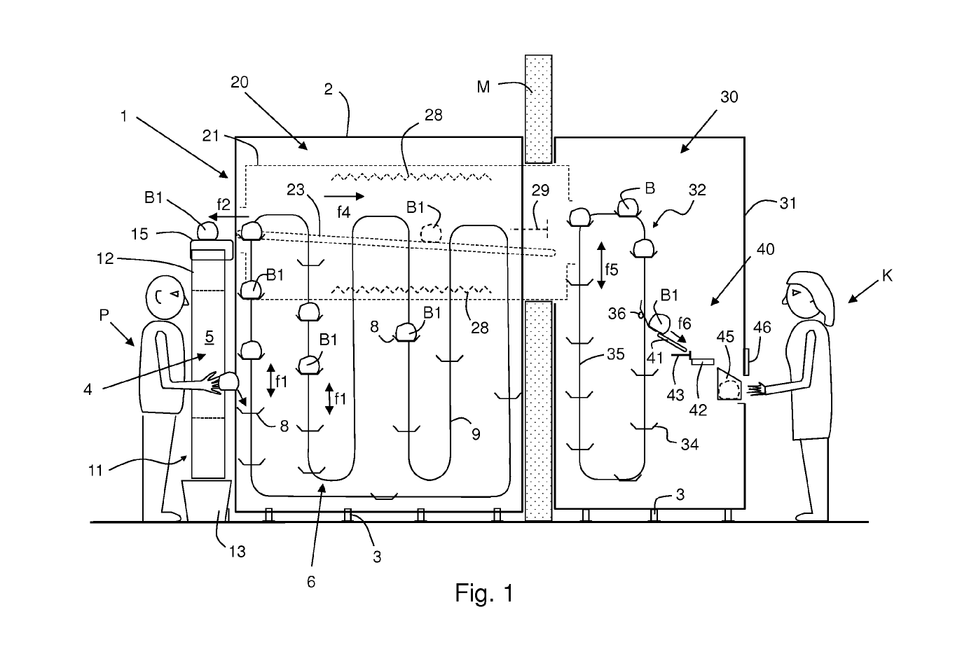

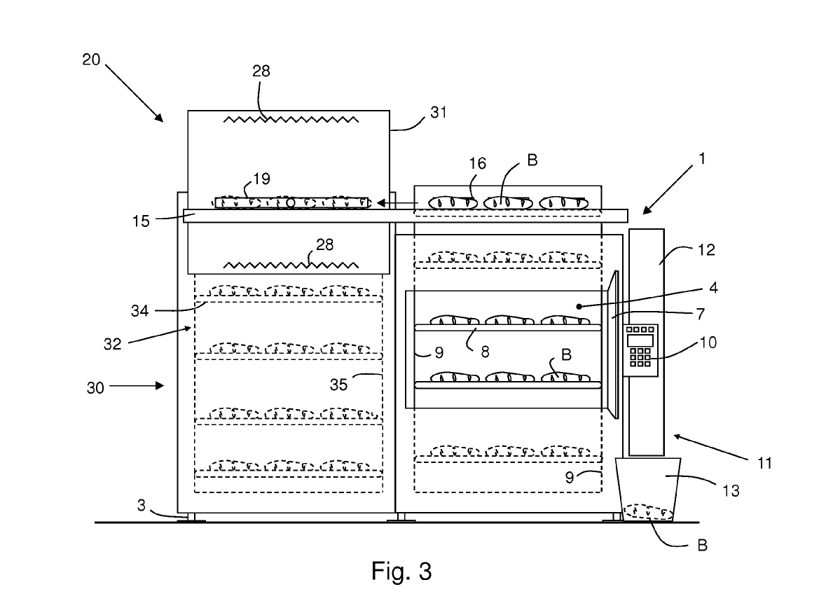

FIGS. 1-3 show schematic views of a device according to the invention for baking or crisp baking dough pieces, although some parts do not appear in all figures for better clarity. The device has an input storage 1 to which a feeding device 4 is provided. In the embodiment shown, the feeding device 4 has an opening 5 that can be closed by a door 7 (see FIG. 3) through which dough pieces B (rolls, breads, baguettes, pretzels, etc.) can be placed on circulating storage carriers 8 of the input storage 1.

The input storage 1 has a housing 2 standing on feet 3 in which a paternoster-shaped conveyor 6 is arranged that comprises a plurality of elongated storage carriers 8 connected to motorized conveyor chains 9 on their respective front sides. Using an input panel with display 10 (see FIG. 3), the staff can request a free storage carrier 8 (i.e. one not yet filled with baked goods B) using a corresponding control (not shown). In addition, instructions for the staff can be issued on the display 10, for example what kind of baked goods should be baked owing to current customer demand. The first conveyor 6 circulates in direction of the double arrow f1 and can thus be operated in both directions. Especially when a free carrier 8 is requested for filling with baked goods B, it is appropriate for shortening the travel time of a corresponding carrier 8, if need be.

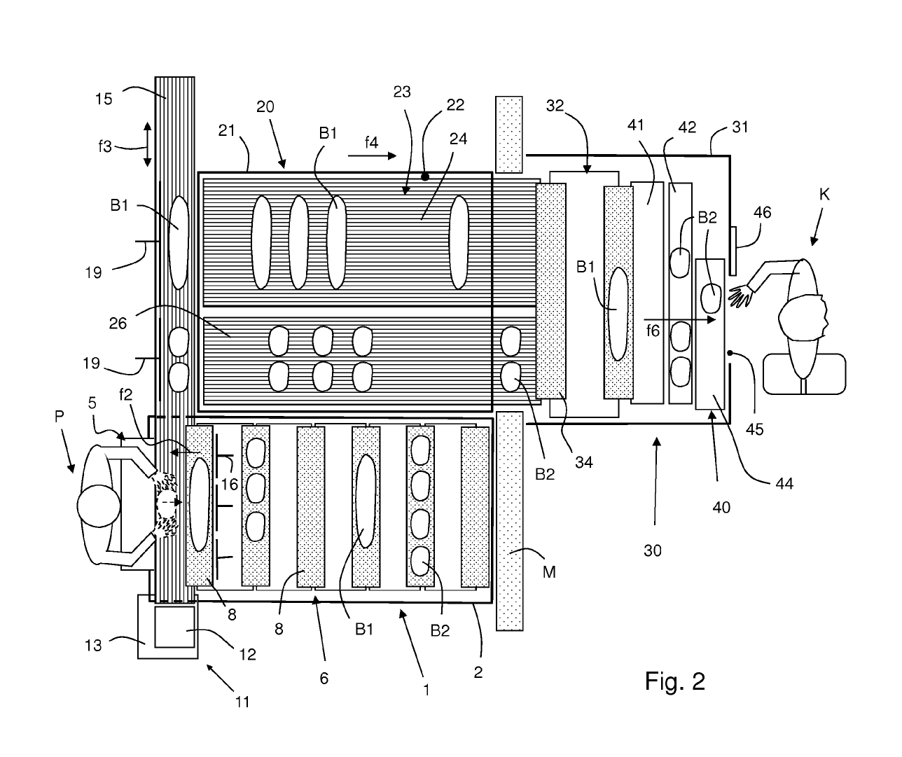

The pre-baked or still unbaked baked goods B are stored in the circulating conveyor 6 until a control signal from the controller (not shown) allows their further transportation. For this purpose, a linear conveyor executed as conveyor belt, for example, has been provided in the upper area, on the side facing the serving staff P, to run sideways towards the longitudinal extension of the storage carriers 8. As can be seen especially in FIGS. 1 and 2, baked goods B are pushed from a storage carrier 8 transported to the respective position to the linear conveyor 15 (arrow f2) through sliders 16. Other transfer mechanisms are by all means possible, such as by tipping over the baked goods B from the storage carriers 8 to the linear conveyor 15.

The running direction of the linear conveyor 15 is reversible (see double arrow f3). While running forward, the linear conveyor 15 transports the baked goods B to a throughput baking oven 20 to be described below. Here, motorized sliders 19 are provided to transport the baked goods B from the linear conveyor 15 to the throughput baking oven 20.

Furthermore, a collection device 11 located on its front side facing away from the oven unit 20 has been provided for the linear conveyor 15. In this case, the collection device 11 consists of a drop shaft 12 running perpendicularly and a collection container 13 placed below so that it can be manually emptied. When baked goods B cannot be successfully pushed from the linear conveyor 15 to the transportation device 23 within oven unit 20, the conveying direction of the linear conveyor 15 is reversed and operated until all baked goods B that are still on it can be dropped into the drop shaft 12.

The throughput baking oven 20 (hereinafter “oven”) is installed in a housing 21 and indicated with a dashed line in FIG. 1 because it is arranged behind the input storage 1 and therefore is actually not visible in the lateral representation of FIG. 1. Heating elements 28 are shown schematically in the oven 20 and fans could still be advantageously provided to distribute the heated air quickly and uniformly in the oven space 22. The transportation device as shown is a conveyor 23 on which the dough pieces B to be baked are placed runs through the oven space 22. The conveyor 23 is described further below as an essential component of the invention.

The oven unit 20 is accessible from below because the interposition of the linear conveyor 15 redirects the baked goods twice by 90°. Thus, the open unit 20 is very easily accessible to the serving and service staff.

Attached to the throughput oven 20 is an output storage 30, which stores the freshly baked dough pieces B and dispenses one dispensing unit 40 after a customer request. The housing 31 of the output storage 30 standing on feet 3 is intended for placement in a supermarket sales space or the like. To minimize the standing area of the device according to the invention, the input storage 1 and the throughput baking oven 20 are placed outside of the sales area and separated from it by a wall M.

After baking or crisp baking, a slider 29 (shown only in FIG. 1) pushes the freshly-baked goods B onto the circulating storage carrier 34 of a second circulating conveyor 32 shaped like a paternoster (arranged in the output storage and driven by front-sided conveyor chains 35) from the conveyor 23 all the way to storage for delivery to a customer K. The second conveyor 32 can be operated according to the double arrow f5 with reversible rotating direction. A corresponding serving unit 46 for the customer K has a display and keys, for example, for requesting the various available baked goods B, which are offered to the customer K in a dispensing tray 45 for taking.

An intermediate storage 42 is provided between the conveyor 32 and the dispensing tray 45 on which the baked goods B are dumped by a storage carrier 34 according to the embodiment shown here. To do this, the storage carrier 34 to be emptied runs from above, against pins 36 movable by electronic control, to a resting and working position and this storage carrier 34 is swiveled towards the dispensing tray 45. After the request of customer K, the baked goods B then slide (arrow f6) on the above-mentioned intermediate storage 42 on a first chute 41 inclined towards the dispensing tray by means of a slider 43 into a funnel chute 44—transversally inclined towards the dispensing tray 45—on which the requested baked goods B slide to the dispensing tray 45.

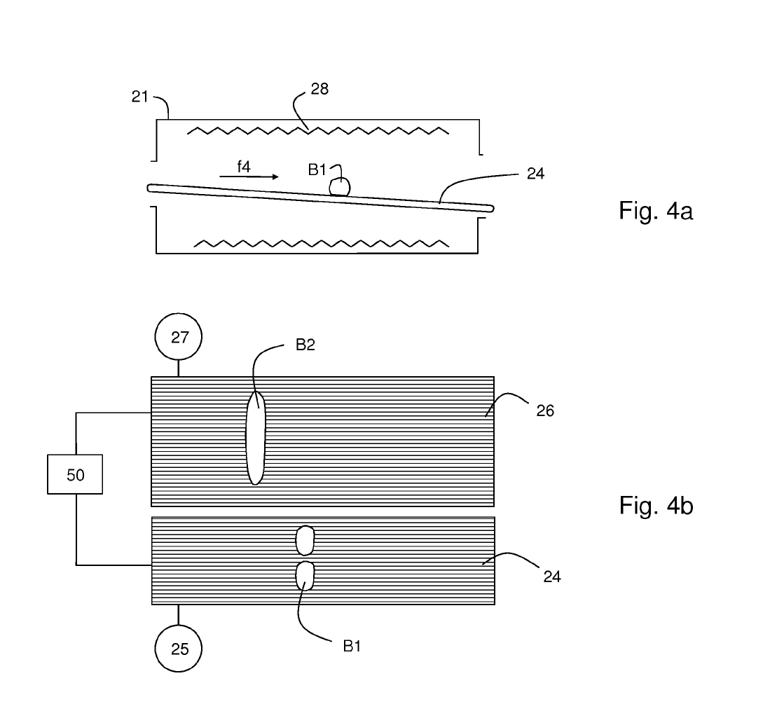

Coming back to the throughput oven 20, the above-mentioned conveyor 23 comprises at least two conveyor belts 24, 26 circulating through the oven space 22 that transport the dough pieces B to the output storage 30 in the direction of the arrow f4. Here, it is important for only one single oven space 20 to exist. According to the embodiment shown, the two conveyor belts 24, 26 (which can be developed as circulating chain links or net conveyors) are arranged to run parallel beside one another according to the embodiment shown and slightly inclined downward in transportation direction (see FIGS. 1 and 4a). At the same time, the baked goods B can be transported through the oven space 22 on both conveyor belts 24, 26. Preferably, the dough pieces B on the conveyor belts 24, 26 are of various kinds, as indicated by reference characters B1 and B2, whereby B1 symbolizes here rolls and B2 baguettes. Contrary to the state of the art, with the device according to the invention one can bake various kinds of dough pieces in the same oven space on different conveyor belts.

In the embodiment shown, the conveyor belts 24, 26 have different widths, as can be seen especially in FIGS. 2 and 4. When the belts are arranged close to one another without an appreciable gap, great flexibility of the dough pieces to be baked or crisp baked can be achieved without having to accept compromises in the overall width.

An electric control device 50, to adjust the speeds of the two conveyor belts 24, 25 independently from one another, is shown schematically in FIG. 4. Here, the control device controls the motor 25 and 27 of the first and second conveyor belt 24 and 26, respectively. Thus, the conveyor belt 24 or 26 intended for dough pieces that need to be baked slower and more crispy can also move slower through the oven space 22, whereas dough pieces that need to be baked faster and less crispy being transported on the other conveyor belt 26 or 24 move faster through the oven space 22, thereby achieving a considerable increase in efficiency.

The control 50 can alternately or additionally be set up and executed in such a way that a different timing for the dwelling time of preferably intermittently transporting dough pieces B1, B2 is adjustable in the baking oven 20. In this way, the conveyor belts 24, 26 can move with the same or different speed through the oven space 22. One or the two conveyor belts 24, 26 can stop once or several times in the oven space 22. For example, one conveyor belt 24 or 26 can stop while the other conveyor belt 24 or 26 keeps moving.

In this case, it is also possible for both conveyor belts 24, 26 to be driven by the same motor—i.e. to move equally fast in principle—but be stopped temporarily by a slip clutch or similar device in one of the two conveyor belts 24 or 26, prompted by the control device 50.

With the invention, it is possible to bake or crisp bake a larger number of different dough pieces very efficiently and flexibly. For example, it is also possible to transport more than just one type of dough piece (i.e. not only dough pieces B1 and B2) on one or the two conveyor belts 24, 26. On conveyor belt 24, larger rolls can be arranged near the dispensing area, smaller rolls in the middle and once again larger rolls near the feeding area, for example. Similarly, different dough pieces can be placed on the conveyor belt 26. Then, using the design according to the invention, it is possible to allow the conveyor belt 24 to run relatively slowly so the larger rolls are sufficiently crisped up. Once they are dispensed, the motor 25 is controlled for faster movement of the conveyor belt 24 until the smaller rolls have been dispensed. Afterwards, the conveyor belt 24 once again runs slower so the last larger rolls do not leave the oven too quickly. Since a comparable procedure regarding the second conveyor belt 26 can be implemented—namely fully independently from the first conveyor belt 24—the result is great flexibility and variability.

The present invention is not restricted to the embodiments shown. Deviations within the claims are readily possible.

1. A device for selectively baking or crisp baking dough pieces based on a customer request for requested baked goods, the device comprising:
at least one input storage and at least one associated feeding device for respectively storing and feeding various kinds of dough pieces;
a throughput baking oven for selectively baking or crisp baking the dough pieces, the throughput oven having a conveyor for transporting the dough pieces from the at least one input storage through the baking oven, the throughput oven having only one oven space, the conveyor having at least two conveyor belts passing through the oven space capable of simultaneously transporting dough pieces through the oven space;
at least one output storage for receiving and storing the dough pieces baked into baked goods in the baking oven; and
at least one dispensing unit for the baked goods, whereby after the customer request made through an operating unit, the requested baked goods are transported from the at least one output storage to the dispensing unit to be dispensed.

2. A device according to claim 1, wherein the at least two conveyor belts run parallel to one another.

3. A device according to claim 1, wherein the conveyor belts have different conveyor widths.

4. A device according to claim 1, further comprising an electrical control device to independently adjust a speed of each of the conveyor belts.

5. A device according to claim 4, wherein the speeds of the conveyor belts can be adjusted in a variable way.

6. A device according to claim 1, further comprising an electrical control device capable of adjusting a dwelling time of dough pieces in the baking oven.

7. A device according to claim 1, wherein the at least one input storage, the throughput baking oven and the at least one output storage are arranged in different housings.

8. A device according to claim 1, further comprising endless belts on which storage carriers circulate in a substantially vertical path to accept dough pieces or baked goods in the respective output storage, the endless belts being guided in a meandering manner and being arranged in at least one of the at least one input and output storage.

9. A device according to claim 1, wherein a transportation path for the dough pieces is non-linear from the input storage to the throughput baking oven.

10. A device according to claim 9, wherein the transportation path changes directions by about 90° at least once.

11. A device according to claim 1, further comprising a transportation device which transports the dough pieces from the input storage to the throughput baking oven arranged above and running across a width of the feeding device.

12. A device according to claim 1, wherein the throughput baking oven is a convection oven.

13. A device according to claim 6, wherein the electrical control device is capable of adjusting the dwelling time of the dough pieces in the baking oven by causing the conveyor belts to move intermittently.
